(19) United States
(12) Patent Application Publication
(10) Pub. No.: US 2009/0304337 A1
(43) Pub. Date: Dec. 10, 2009

(54) OPTICAL SUB-ASSEMBLY ELECTRICALLY ISOLATING FRAME GROUND FROM SIGNAL GROUND

(75) Inventor: Shunsuke SATO, Yokohama-shi (JP)

Correspondence Address: VENABLE LLP, P.O. BOX 34385, WASHINGTON, DC, 20043-9998, US

(73) Assignee: SUMITOMO ELECTRIC INDUSTRIES, LTD., Osaka-shi (JP)

(21) Appl. No.: 12/498,610

(22) Filed: Jul. 7, 2009

(30) Foreign Application Priority Data
Jun. 5, 2008 (JP) 2008-147707

(51) Int. Cl. G02B 6/36

(52) U.S. Cl. 385/92

(57) ABSTRACT

An optical sub-assembly (OSA) able to rigidly hold the sleeve and to isolate the frame ground from the signal ground is disclosed. The OSA provides the optical device and the sleeve assembly including the stub, the stub holder, the sleeve and the ring member. The stub holder is made of electrically conductive material and is electrically connected with the optical device. The ring member is made of electrically conductive material and is connected to the housing of the equipment in which the OSA is installed. The sleeve, which is made of insulating material, receives the stub holder in a portion thereof, and is press-fitted into the ring member in a second portion thereof. The frame ground of the housing is electrically isolated from the signal ground of the optical device by the insulating sleeve, and the first and second portions of the sleeve are overlapped along the longitudinal axis of the sleeve.

### BACKGROUND OF THE INVENTION

1. Field of the Invention

The present invention relates to an optical sub-assembly applicable to an optical transceiver.

2. Related Background Art

An optical sub-assembly (hereafter denoted as OSA) comprises an optical device that includes an optical-to-electrical or electrical-to-optical converting device, such as semiconductor laser diode (hereafter denoted as LD) or semiconductor photodiode (hereafter denoted as PD) and an optical coupling member such as sleeve to couple an external fiber with the LD or the PD in the optical device. FIG. 5 illustrates a cross section of a well-known OSA, which has been disclosed in the U.S. patent, U.S. Pat. No. 7,322,752. The OSA 100 shown in FIG. 5 is a type of a receiver optical subassembly (hereafter denoted as ROSA) and comprises an optical device 102, a sleeve assembly 103 and a joint sleeve 104 (hereafter denoted as J-sleeve). The optical device 102 is assembled with the sleeve assembly 103 through the J-sleeve.

The sleeve assembly 103 includes a stub 105 and a sleeve 106. The stub 105 guides light provided from an external fiber set in the sleeve assembly 103 to the optical device 102, while, the sleeve 106 made of ceramics supports the ferrule C of the optical connector and the stub 105. The sleeve assembly 103 also provides a metallic holder 107 to which the stub 105 and the sleeve 106 are fixed. Thus, the sleeve assembly 103 in the metallic holder 107 thereof is attached to the J-sleeve 104.

The OSA 100 enhances the EMI (Electro-Magnetic Interference) or the EMS (Electro-Magnetic Susceptibility) performance of the OSA 100 and the optical transceiver that installs this OSA 100 by the insulating sleeve 106. Moreover, the optical device 102, especially, the semiconductor optical device 101 installed in the optical device 102 is physically apart from the electrically conductive components provided within the optical connector by interposing the electrically insulating components, 105 and 106, which prevents the damage of the semiconductor device 101 in the optical device by the electro-static discharge.

The optical transceiver that installs the OSA 100 shown in FIG. 5 provides an optical receptacle to set the OSA 100 therein and a mainframe that installs the electronic circuit electrically coupled with the OSA 100 and communicates with the host system. Generally, a partition wall separates the optical receptacle from the mainframe, and this partition wall provides a structure to assemble the OSA 100 with the optical transceiver.

The U.S. Pat. No. 7,322,752 has disclosed an arrangement to set the OSA 100 within the optical transceiver, which is schematically illustrated in FIG. 5, where an insulating ring member 108 covers the metallic holder 107 and the wall W of the housing that has an opening W1, into which the sleeve portion of the OSA 100 is inserted, holds this insulating ring member 108. Thus, the electrical isolation between the metallic holder 107 and the wall W may be realized. The metallic holder 107 is electrically connected to the optical device 102 through the J-sleeve 104, and the shell of the optical device 102, in particular, the stem on which the semiconductor optical device if mounted is connected to the signal ground. The arrangement of the optical sub-assembly 100 may electrically isolate the signal ground from the housing.

The insulating member 108 is not restricted in the arrangement thereof to those shown in FIG. 5 to isolate the SG from the housing. For instance, the insulating ring member is offset along the longitudinal axis of the sleeve, which shows the side-by-side arrangement with respect to the metallic holder 107, and directly comes in contact with the sleeve 106. The wall W of the housing only holds the insulating ring member 108 so as not to come in physically contact with the metallic holder 107. This arrangement may isolate the signal ground from the housing.

However, the conventional OSA 100, because the metallic holder 107 directly holds the stub 105 in about half length thereof along the longitudinal direction, and the sleeve 106 holds the rest half length of the stub, the ferrule C inserted into the sleeve 106 is sensitive to a force F applied along the horizontal direction, orthogonal to the longitudinal axis of the sleeve 106. This phenomenon is often called as the Wiggle characteristic, that is, inserting the ferrule provided in the end of an external fiber, and wiggling the external fiber, the optical coupling efficiency between the optical fiber and the semiconductor optical device 101 fluctuates. The arrangement shown in FIG. 5 may easily tilt the sleeve 106 when the ferrule C receives the horizontal force F; while, the stub 105 is rigidly fixed to the wall W through the insulating ring member 108 and the metallic holder 107, thus, the optical coupling between the tip end of the ferrule and that of the stub 105 easily misaligned.

### SUMMARY OF THE INVENTION

An aspect of the present invention relates to an optical sub-assembly that comprises at least an optical device and a sleeve assembly. The optical device installs at least a semiconductor optical device. The sleeve assembly has a feature that it comprises a stub, a stub holder electrically connected to the optical device, an electrically insulating sleeve, and a ring member electrically connected to a housing in which the optical sub-assembly is installed. The sleeve holds the stub holder directly or indirectly through the stub, and the ring member holds sleeve directly. The ring member is electrically isolated from the stub holder by sleeve, thus, the frame ground of the housing is isolated from the signal ground of the optical device.

The sleeve maybe made of ceramics, such as zirconia. The stub may be press-fitted into the stub holder and into the sleeve, and the sleeve may be press-fitted into the ring member. A first portion of the sleeve, where the sleeve is press-fitted into the ring member, and a second portion of the sleeve, where the stub is press-fitted into the sleeve, are overlapped each other along the longitudinal direction of the sleeve. This arrangement may further stably hold the sleeve even the ring member is rigidly set in the housing. Moreover, the stub holder may be press-fitted into the sleeve at a third portion of the sleeve, and the first and third portions of the sleeve may be overlapped to each other along the longitudinal direction of the sleeve. This arrangement may further rigidly hold the stub holder and the stub by the sleeve.

### BRIEF DESCRIPTION OF DRAWINGS

FIG. 1 is a cross section on an optical sub-assembly according to an embodiment of the present invention;

FIG. 2 is a cross section of the sleeve assembly applied to the optical sub-assembly shown in FIG. 1;

FIG. 3 is a cross section of the optical transceiver with the optical sub-assembly illustrated in FIG. 1 in a state where the optical connector is inserted into the optical transceiver;

FIG. 4 is a cross section of a modified sleeve assembly according to another embodiment of the present invention;

FIG. 5 is a cross section of a conventional optical sub-assembly where the optical sub-assembly is set in the optical transceiver.

### DETAILED DESCRIPTION OF PREFERRED EMBODIMENTS

An optical sub-assembly according to the present invention is applicable to, for instance, a transmitter optical sub-assembly (hereafter denoted as TOSA) that provides a semiconductor laser diode (hereafter denoted as LD), or a receiver optical sub-assembly (hereafter denoted as ROSA) that provides a photodiode (hereafter denoted as PD). The description presented herein concentrates on the TOSA, however, similar descriptions maybe carried out for the ROSA. In the description of the drawings, the upper side along to the optical axis O corresponds to a side where the opening 10c of the sleeve 10 is formed.

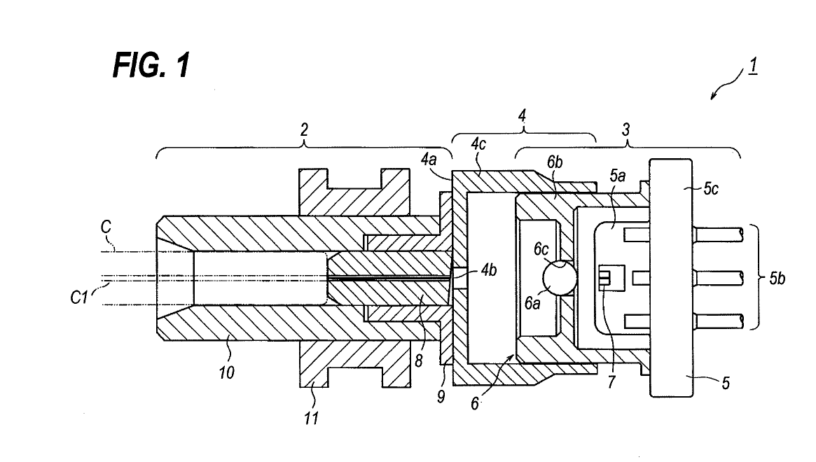

FIG. 1 is a cross section of the TOSA according to an embodiment of the invention. The TOSA 1 includes a sleeve assembly 2, an optical device 3, and a joint sleeve 4 (hereafter denoted as J-sleeve). The sleeve assembly 2 guides an optical ferrule C provided in an external optical connector to align the ferrule C optically with respect to the optical device. The optical device converts an electrical signal into an optical signal and transmits this optical signal to an external fiber Cl secured in a center portion of the optical ferrule C. The J-sleeve 4 assembles the optical device 3 with the sleeve assembly 2. The TOSA 1 of the present embodiment has a feature in the sleeve assembly 2, but the optical device 3 and the J-sleeve will be described in detail in advance to the description of the sleeve assembly 2.

The optical device 3 comprises a stem 5, a cap 6 and an LD 7 enclosed within a space formed by the stem 5 and the cap 6. The stem 5, which constitutes a CAN package accompanied with the cap 6, includes a block 5a whose side surface mounts the LD 7 thereon, a plurality of lead pins 5b and a base 5c that supports the lead pins 5b. The lead pins 5b and the base 5c are made of electrically conductive material, typically, Kovar which is an alloy of iron (Fe) and nickel (Ni). The lead pins 5b, supported by the base 5c through an insulating material such as seal glass, are connected to respective wiring patterns on a circuit board. At least one of lead pins 5b is directly connected to the base 5c without any insulating material by, for instance, the welding in one end thereof; while, the other end of one of the lead pins 5b is soldered with the signal ground (hereafter denoted as SG) provided on the circuit board to keep the potential of the base 5c in the SG. The other of lead pins 5b, which are electrically isolated from the base 5c by, for instance, a seal glass, supplies the electrical power to the LD 7 or transmits the driving signal for the LD 7.

The cap 6 provides a lens 6a and a shell 6b that supports the lens 6a. The shell 6b is also made of electrically conductive material, such as Kovar or stainless steel, and has an aperture 6c in a center of a ceiling thereof. Within the aperture is set with the lens 6a with a seal glass. The bottom end of the shell 6b is fixed to the base 5c by the resistance welding. The LD 7, driven by an electrical signal supplied through the lead pins 5b, transmits an optical signal corresponding to the electrical signal through the lens 6a. The LD 7 is mounted on the side surface of the block 5a. Thus, the base 5c and the shell 5b air-tightly seal a space where the LD 7 is set therein.

The J-sleeve 4, which is made of electrically conductive material such as stainless steel, has a flat end surface 4a on which the sleeve assembly 2 is fixed after the optical alignment between the optical device 3 and the sleeve assembly 2 by the YAG laser welding. Specifically, the flange of the stub holder 9, which will be described in detail later, is welded on the top flat surface of the J-sleeve 4a by the YAG laser welding. The optical alignment between the optical device 3 and the sleeve assembly 2 may be carried out as follows:
(1) sliding the sleeve assembly 2 on the J-sleeve 4 as the flange of the stub holder 9 comes in contact with the top flat surface 4a of the J-sleeve, which performs the optical alignment within a surface perpendicular to the optical axis C; and
(2) sliding the skirt portion 4c of the J-sleeve 4 along the outer surface of the shell 6b of the cap 6, which carries out the optical alignment along the optical axis O; specifically, which adjusts a distance between the lens 6a and the end of the stub 8. The top surface 4a of the J-sleeve 4 provides an aperture 4b through which the light emitted from the LD 7 passes.

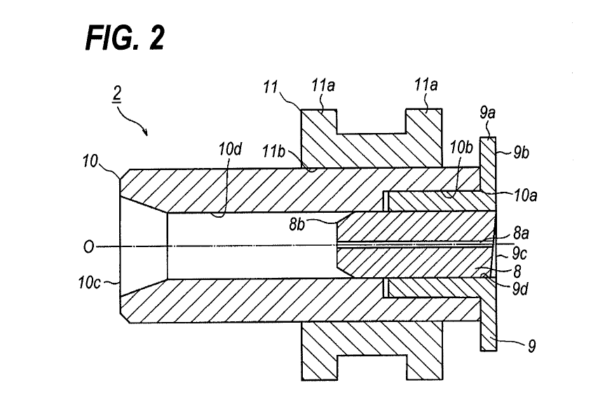

The sleeve assembly 2 will be described in detail. FIG. 2 is a cross section of the sleeve assembly 2. The sleeve assembly 2 includes the stub 8, the stub holder 9, the sleeve 10 and the ring member 11. Press-fitting the stub 8 into the stub holder 9, and the assembly of the stub 8 with the stub holder 9 into the end of the sleeve 10, and finally the assembly of the sleeve 10, the stub holder 9 and the stub 8 into the ring member 11, the sleeve assembly 2 is completed.

The stub 8, which is typically made of ceramics such as zirconia, optically couples the external fiber C1 secured in a center portion of the ferrule C of the optical connector with the LD 7. The stub 8 has a cylindrical shape with the coupling fiber 8a in a center thereof along the optical axis O. The top surface 8b of the stub 8 has a convex surface in order to come in physically contact with the end surface of the ferrule C. The end surface of the ferrule C may be formed in convex to secure the physical contact with the stub 8.

The stub holder 9, which is also made of electrically conductive material such as stainless, supports the stub 8 and has a substantially cylindrical shape. The stub holder 9 provides a flange 9a in one end portion thereof. As previously described, this flange 9a is fixed with the J-sleeve 4 as the end surface 9b thereof faces and comes in contact with the top surface 4a of the J-sleeve 4 after optically aligning the sleeve assembly 2 with the optical device 3. The stub 8 is press-fitted within the aperture 9d of the stub holder 9 extending from the end 9c along the optical axis O.

The sleeve 10, which is made of electrically insulating material preferably ceramics such as zirconia and has a substantially 5 cylindrical shape, receives and guides the ferrule C of the external optical connector. The sleeve 10 includes an aperture 10b extending from one end 10a thereof along the optical axis O in a length comparable to the length of the stub holder 9. The assembly of the stub holder 9 with the stub 8 is press-fitted within this aperture 10b. The sleeve 10 provides another aperture 10d extending from the other end 10c thereof along the optical axis O. The other aperture 10d continues with the first aperture 10b. This aperture 10d receives the ferrule C in one side thereof; while, the aperture 10d also receives the end portion of the stub 8 in the other side thereof. A portion close to the end 10c is chamfered to facilitate the insertion/extraction of the ferrule C.

Inserting the ferrule C into the aperture 10d from the side 10c, the end surface of the external fiber C1 set in a center of the ferrule C comes in physically contact with the end of the coupling fiber 8a set in a center of the stub 8 press-fitted into the aperture 9d of 20 the stub holder, which establishes the optical coupling between the coupling fiber 8a with the external fiber C1 in the ferrule C. Moreover, the coupling fiber 8a in the stub 8 is optically aligned with the optical device 3, specifically, with the LD 7 in advance to the insertion of the ferrule C into the sleeve 10. Accordingly, the LD 7 may be optically 25 coupled with the external fiber C1 in the ferrule C through the coupling fiber 8a in the stub 8.

Next, the ring member 11, which is a feature of the present invention, will be described in detail. The ring member 11 assembles the TOSA 1 with the optical transceiver, which is not shown in figures, installing the TOSA 1 or ROSA therein. The ring member 11 may be made of electrically conductive material, for instance, a stainless steel, and has a substantially cylindrical shape. The ring member 11 provides a pair of flanges 11a in both ends thereof along the optical axis. The TOSA 1 is set in the optical transceiver such that these flanges 11a put a structure of the optical transceiver therebetween. The ring member 11 receives the sleeve 10 in the aperture 11b thereof extending along the optical axis O. The sleeve 10 is press-fitted into this aperture 11b.

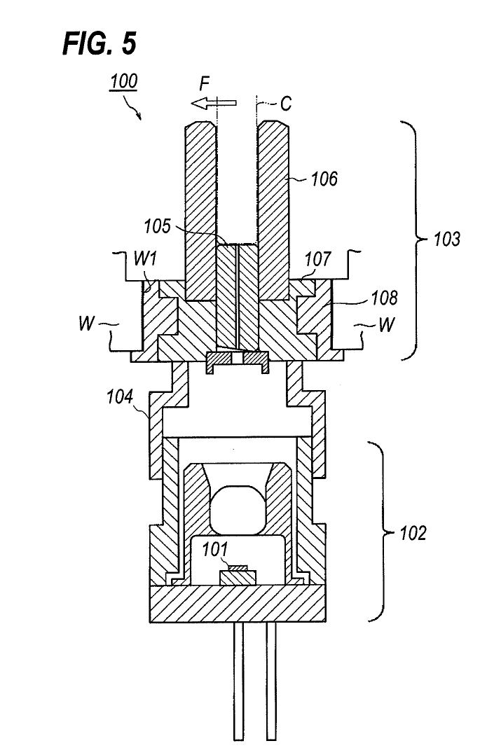

In a conventional optical sub-assembly, the insulating member 107 and the calking member 108 illustrated in FIG. 5 corresponds to the ring member 11 of the present embodiment. The optical sub-assembly 100 is supported such that only an edge portion of the insulating member 107 along the optical axis holds and secures the sleeve 106. On the other hand, the sleeve 10 of the present embodiment passes through the ring member 11. Thus, when the optical ferrule attached to the tip end of the optical fiber is inserted in and secured by the sleeve 10, and this external optical fiber is wiggled, the optical coupling condition between the external fiber and the coupling fiber 8a, which is, what is called as, the wiggle characteristic. The arrangement of the sleeve with the ring member according to the present embodiment shows a preferable performance against the wiggle characteristic because the ring member 11 holds the sleeve 10 in the whole length thereof along the optical axis, thus, the ring member 11 may securely hold the ferrule C through the sleeve 10.

Moreover, the ring member 11, although it is an electrically conductive and connected to the frame ground (FG) of the optical transceiver on which the optical sub-assembly 2 is to be installed, forms a gap with respect to the stub holder 9, which is also electrically conductive and connected to the signal ground (SG) isolated from the FG in the optical transceiver. Between the ring member 11 and the stub holder 9 is provided with the sleeve 10 which is made of electrically insulating material. Thus, the present arrangement of the optical sub-assembly 2 may electrically isolate the FG from the SG.

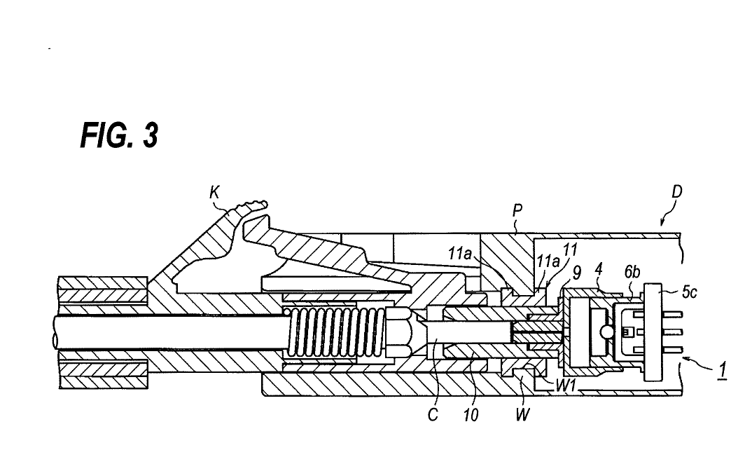

FIG. 3 is a cross section showing a condition where the optical sub-assembly 1, which is installed within the optical transceiver D, receives the optical connector K. The optical sub-assembly 1 is set within the optical transceiver D such that the groove formed by two flanges 11a of the ring member 11 receives the partition wall W of the housing P made of electrically conductive material. Because the housing P is electrically connected to the FG, the ring member 11 is grounded to the FG. On the other hand, the stub holder 9 is coupled with the stem 5c through the J-sleeve 4 and the shell 6b, and these members are made of electrically conducting material; the stub holder 9 is grounded to the SG.

Thus, the optical sub-assembly 1 according to the present embodiment may securely isolate the FG from the SG; accordingly, noise due to the electro-static discharge (ESD) caused on the FG may be prevented from conducting to the SG within the optical transceiver D. Moreover, because the ring member 11 is made of electrically conductive material and connected to the FG, an opening opened to the outside of the transceiver and not shielded with any electrically conductive material may be narrowed to a size substantially equal to the diameter of the sleeve 11, which may enhance the electromagnetic interference (EMI) performance of the optical transceiver D. Moreover, because the sleeve 10 is made of electrically insulating material, the sleeve 10 has no function to induce the antenna effect, specifically, the noise generated by an electrical circuit within the housing P may be prevented from being radiated to the outside through the sleeve 10.

The stub 8 is press-fitted into the stub holder 9, and the stub-holder 9 is also press-fitted into the sleeve 10 in the present optical sub-assembly. Moreover, thus press-fitted sleeve assembly, 2 is press-fitted into the ring member 11, which may shorten the total length of the sleeve assembly 2. When the sleeve 10 is made of zirconia, while, the stub holder 9 is made of stainless steel, the press-fitted coupling between them may be stably held under various temperatures because the thermal expansion co-efficient of those members show a comparably value of 11 ppm/° C.

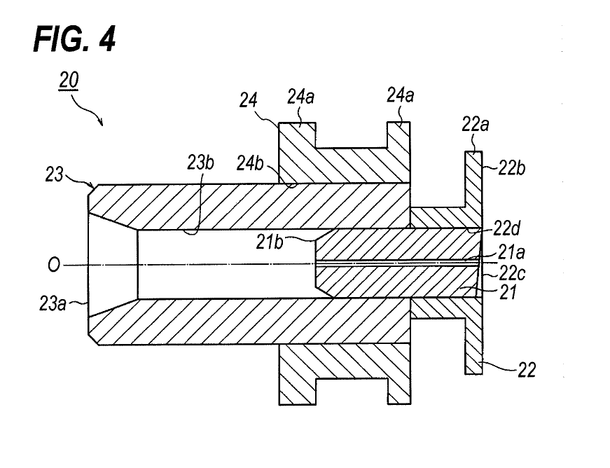

FIG. 4 shows a modified optical sub-assembly according to the second embodiment of the present invention. The sleeve assembly 20, whose cross section is illustrated in FIG. 4, provides the stub 21, the stub holder 22, and the sleeve 23 in addition to the ring member 24. The functions of these members and the materials constituting respective members are same with those illustrated in FIG. 2 and described above. First, press-fitting the sub 21 into the stub holder 22, second press-fitting a rest portion extruding form the stub holder 22 into the sleeve 23, finally press-fitting the sleeve 23 with the stub 21 and the stub holder 22 into the ring member 24, the sleeve assembly 20 according to the present embodiment may be completed.

The stub 21, having substantially cylindrical shape, provides the coupling fiber 21a in a center thereof and the convex end surface 21b. The stub holder 22, which also has a cylindrical shape, provides in the end portion thereof a flange 22a to be fixed to the J-sleeve. The stub holder 22 also provides a bore 22d from the end 22c along the optical axis O into which the stub 21 is press-fitted. This aperture 22d has about half distance of the stub 21. The sleeve 23, which also has a cylindrical shape, provides a bore 23b from the end 23a to the other end along the optical axis O, into which the top half of the stub 21 is press-fitted.

The ring member 24, which also has a cylindrical shape similar to the ring member illustrated in FIG. 2, provides flanges 24a in both ends thereof and a bore 24b into which the insulating sleeve 23 is press-fitted. Even in the arrangement of the present embodiment shown in FIG. 4, the ring member 24, although it is electrically conductive, may be electrically isolated from the stub holder 22 which is grounded in the SG by fixing in the flange 22 thereof to the J-sleeve. Thus, the optical sub-assembly 20 illustrated in FIG. 4 shows an superior EMI performance and EMS performance, stably holds and fixes the sleeve, and reliably isolates the SG from the FG. Because the portion of the sleeve 23 press-fitted into the ring member 24 receives the stub 21 by the press-fitting, in other words, the portion of the sleeve press-fitted into the ring member and the portion of the stub press-fitted into the sleeve are overlapped along the longitudinal direction of the sleeve, which may not only shorten the total length of the sleeve assembly but enhance the reliability of the holding of the stub and the external ferrule.

While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

I claim:

1. An optical sub-assembly that receives an external optical fiber with a ferrule provided in an end thereof and is installed within an electrically conductive housing, comprising:
an optical device arranged to install at least a semiconductor optical device; and
a sleeve assembly to couple said external optical fiber with said optical device optically, said sleeve assembly including,
a stub providing an optical path between said external fiber and said optical device,
a stub holder arranged to hold said stub, said stub holder being made of electrically conductive material and electrically connected to said optical device,
a sleeve arranged to receive and to hold said stub in one end portion thereof and to receive said ferrule in another end portion thereof, said sleeve being made of insulating material and
a ring member arranged to receive said sleeve, said ring member being made of electrically conductive material and electrically connected to said housing but electrically isolated from said stub holder by said sleeve,
wherein said optical device is electrically isolated from said electrically conductive housing.

2. The optical sub-assembly according to claim 1,
wherein said sleeve is made of ceramics.

3. The optical sub-assembly according to claim 2,
wherein said ceramics is zirconia.

4. The optical sub-assembly according to claim 1,
wherein said sleeve is press-fitted to said ring member.

5. The optical sub-assembly according to claim 4,
wherein said stub is press-fitted into said sleeve in one end portion thereof, and into said stub holder in another end portion thereof.

6. The optical sub-assembly according to claim 5,
wherein said stub holder is press-fitted to said sleeve.

7. The optical sub-assembly according to claim 6,
wherein said ring member comes in physically contact to said sleeve by said press-fitting in a first portion of said sleeve, and said stub holder comes in physically contact to said sleeve by said press-fitting in a second portion of said sleeve, and
wherein said first portion and said second portion are overlapped along a longitudinal direction of said sleeve.

8. The optical sub-assembly according to claim 5,
wherein said ring member comes in physically contact to said sleeve by said press-fitting in a first portion of said sleeve, and said stub comes in physically contact to said sleeve by said press-fitting in a third portion of said sleeve, and
wherein said first portion and said third portion are overlapped along a longitudinal direction of said sleeve.
